(19) United States
(12) Patent Application Publication
(10) Pub. No.: US 2005/0264772 A1
(43) Pub. Date: Dec. 1, 2005

(54) Projection device and control method

(76) Inventor: Hidekazu Masukawa, Fukaya-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/107,041

(22) Filed: Apr. 14, 2005

(30) Foreign Application Priority Data
May 28, 2004 (JP) 2004-159494

(51) Int. Cl. G03B 21/00

(52) U.S. Cl. 353/122

(57) ABSTRACT

According to one embodiment of the invention, the projection device features a power-supply control section which selectively supplies power from a power-supply portion. The projection device further comprises a lamp section which emits projection light and radiates the projection light; an operation portion having a plurality of operation switches; a control portion which compares input data, perhaps obtained by depression of predetermined operations switch(es) with a pre-stored authentication code and controls the power-supply control portion to supply the power to the lamp section based on the result of the comparison.

### CROSS-REFERENCE TO RELATED APPLICATION

This application is based upon, and claim the benefit of priority from prior Japanese Patent Application No. 2004-159494, filed May 28, 2004, the entire contents of which are incorporated herein by reference.

### BACKGROUND

1. Field

Embodiments of the present invention relate to a projection device having a lamp section. More specifically, the present invention relates to a projector which supplies electricity power to a lamp section after an authentication process at time of power supply, and a control method.

2. Description of the Related Art

Currently, a large number and wide variety of digital video devices are commonly used. Among them are projectors, such as LCD (liquid crystal display) projectors and DLP (digital light processing) projectors using a light source lamp. These projectors such as LCD projectors feature an authentication process is set to prevent illegal operation by a disinterest person or an outsider.

Japanese Patent Application Laid Open No. 2003-69923 discloses a projector system including a projector and a personal computer. According to the document, an authentication process requiring a password is provided in a configuration where a projector and a personal computer are connected, whereby to prevent interception of video information supplied from the personal computer and to enable imparting a predetermined level of security to the projector.

As described above, in the system for authentication process inputting a password by the user of the personal computer in order to establish communication with the projector according to the password projected on the screen, the projector is already supplied power before the process of projecting the password on the screen. Thus, the projector does not have any authentication process at time of power supply by itself.

However, in such the projector, generally, elements, particularly, the lamp section is an expensive consumable. As such, security measures are necessary to prevent possible events where when the projector is left for a long time with power entered by illegal operation of an undue outsider, the service life of the lamp section is wasted whereby to fade out. Under such circumstances, security measures are demanded for power supply of the lamp section. However, the prior art has a problem in that security measures to protect the lamp section are not available.

### BRIEF DESCRIPTION OF THE DRAWINGS

The features and advantages of the embodiments of the invention will become apparent from the following detailed description of the invention in which:

FIG. 1 is an exemplary block diagram of a configuration of a projector according to one embodiment of the present invention;

FIGS. 2A and 2B are individually exemplary overviews of the projector according to one embodiment of the present invention;

FIG. 3 is a plan section view showing one example of operation switches of the projector according to one embodiment of the present invention;

FIG. 4 is a cross section view showing an exemplary optical configuration of the projector according to one embodiment of the present invention;

FIG. 5 is a plan section view showing one example of an exemplary remote controller used with the projector according to one embodiment of the present invention;

FIG. 6 is a flow chart showing an exemplary authentication operation of the projector according to one embodiment of the present invention; and

FIG. 7 is a flow chart showing an exemplary setting operation of a security function of the projector according to one embodiment of the present invention.

### DETAILED DESCRIPTION

With reference to the accompanying drawings, a projector according to one embodiment of present invention will be described in detail herein below.

The projector according to one embodiment of the invention provides security against a user in the following manner. At time of power supply, an operation sequence associated with a specific operation switch is pre-stored, and an authentication process is set. According to the authentication process, even when a power switch is depressed, unless the operation sequence associated with the specific operation switch set thereafter is present, the electronics power is not supplied to, particularly, the lamp section.

By reference to the drawings, the following will provide a detailed description, particularly, by reference to the projector by way of example.

### A. Configuration of an Embodiment of the Projector

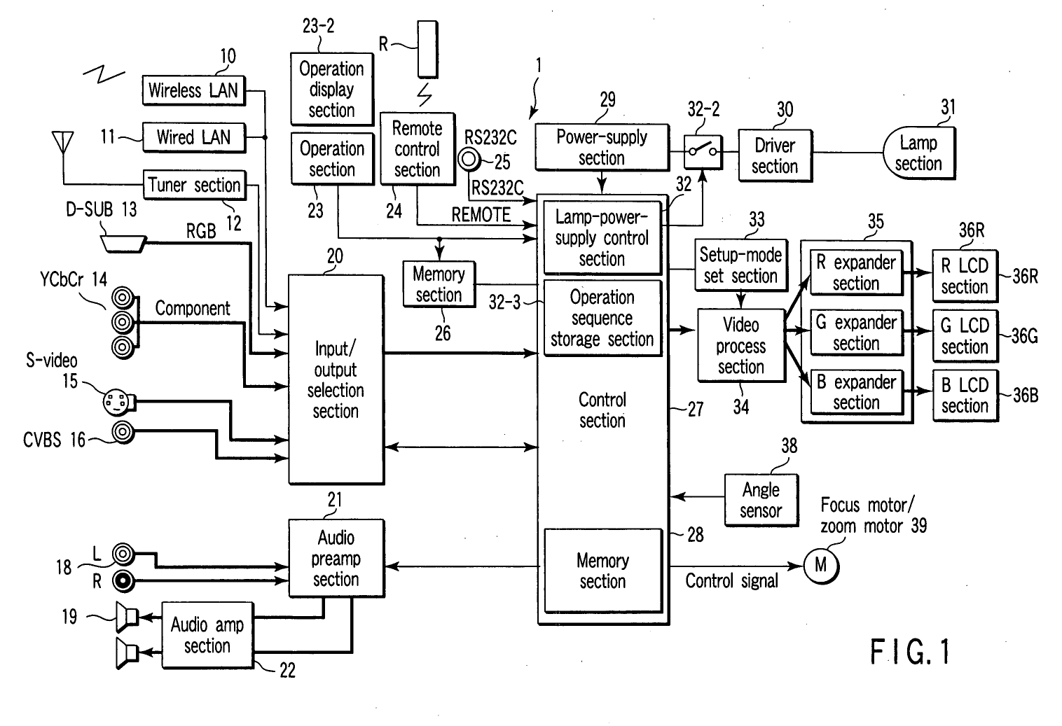

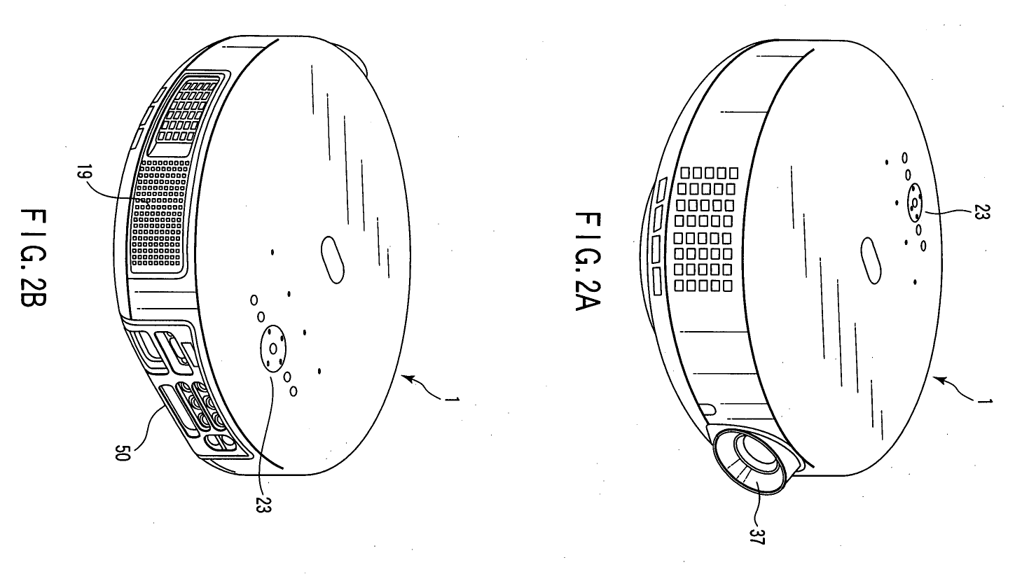

Referring to FIGS. 1, 2A, and 2B, the projector according to the invention is configured as follows. FIG. 1 is a block diagram showing one example of a configuration of a projector according as an embodiment of the present invention. FIGS. 2A and 2B are exemplary overviews of the projector as an embodiment of the present invention.

In general, projector 1 comprises, broadly, an input/output selection section 20, various terminals including LAN connections and a tuner section 12, an audio preamp section 21, an audio amp section 22, an operation section 23, a remote control section 24, a control section 27, a power-supply section 29, a light source (e.g., lamp section) 31, a video section 34 and an expander section 35. The relationship between each section, being hardware and/or software, is as follows.

Various components are connected to the input/output selection section 20. By way of example, there are at least connected a wireless LAN (wireless local area network) 10 used in radio communication in indoors the like; a wired LAN 11; the tuner section 12 which receives a broadcast signal from an antenna and which supplies the received signal; a D-SUB terminal 13, which is shown as being an input/output terminal 50, for connection of, primarily, a computer or the like; a YCbCr terminal 14 for connection to which a commercial-use VTR (video tape recorder), a BS digital tuner, a DVD player, or the like is frequently connected; an S-video terminal 15 used for a VTR, TV set, or the like; and a CVBS (composite video blanking and sync) terminal 16 which is a composite signal.

In addition, an audio terminal 18 is connected to the audio preamp (preamplifier) section 21. The audio preamp section 21 processes an input signal and supplies the processed signal to the audio amp (amplifier) section 22 and a speaker 19. Such processing may include, but is not limited to the adjustment of audio volume, audio quality, acousto-optic effect, and the like.

The input/output selection section 20 supplies selected and video-converted RGB signals to the control section 27. According to control signals from the control section 27, the input/output selection section 20 and the audio preamp section 21 are controlled for their operation and processing.

The projector 1 further includes operation section 23 provided with, for example, a power switch and operation switches; an operation display section 23-2 which displays operation information; a remote control section 24 which performs a communication process to communicate with a remote controller R (shown in FIG. 5); and an RS232C terminal 25 for taking-in control signals and a memory section 26. These components are individually connected to the control section 27 while the operation section 23 and the operation display section 23-2 are deployed on the main body of the projector 1.

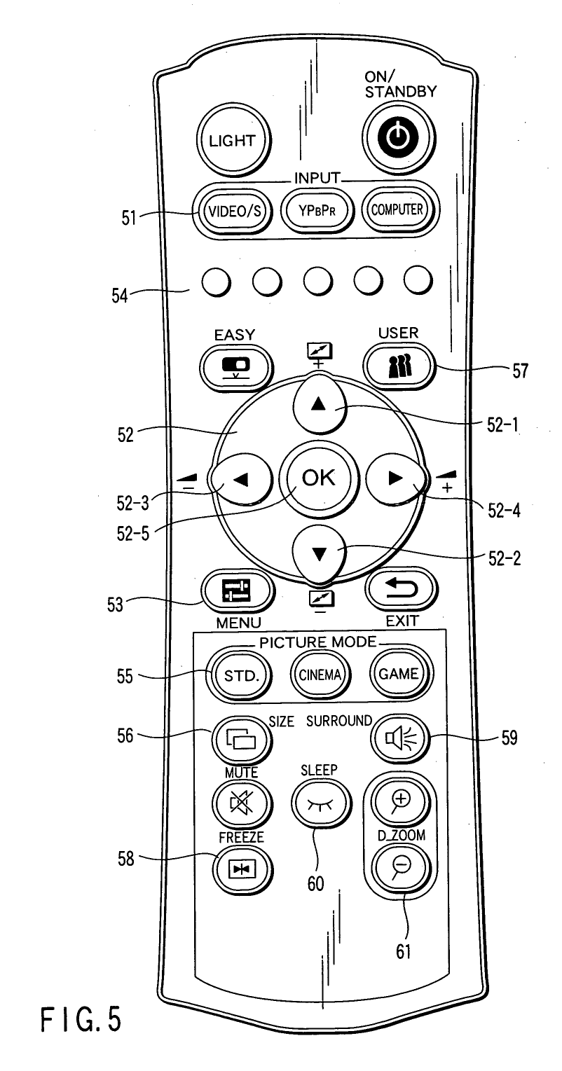

The control section 27 has a memory section 28, a lamp-power-supply control section 32, and an operation sequence storage section 32-3. Additionally coupled to control section 27, for example, an angle sensor 38 which detects the angle of the projector 1 used for keystone correction described below, and a focus motor/zoom motor 39 contained in a lens unit 37 of FIG. 4.

The projector 1 further has a setup-mode set section 33 which sets any one of various setup modes (described below) upon reception of an output of the control section 27; a video process section 34 which performs a video image process upon reception of an output of the setup-mode set section 33 and a video signal from the control section 27; an expander section 35 which expands the video signal, which has undergone the video image process in the video process section 34, in units of each of R, G, and B signals; and an R LCD (liquid crystal display) section 36R, a G LCD section 36G, and a B LCD section 36B which performs image display on, for example, an LCD screen upon reception of an LCD driving current from the expander section 35.

The projector 1 further includes a power-supply section 29. A driving current at a desired output rate is supplied from the power-supply section 29 to a lamp section 31 through a switch section 32-2. In the lamp section 31, projection light having been projected arrives at each LCD section 36R, 36G, and 36B and passes therethrough; and the light is projected as being the light including video images onto a screen (not shown) or the like. Operation of the switch section 32-2 is controlled by the lamp-power-supply control section 32.

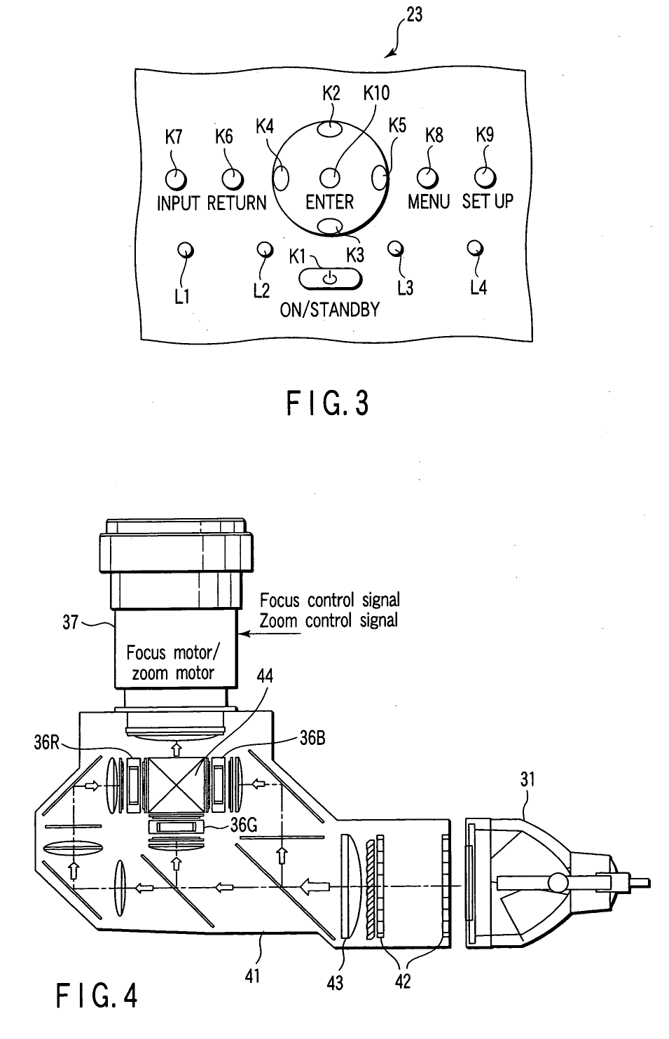

FIG. 3 is a plan section view showing one example of operation switches of the projector as an embodiment of the present invention. Referring now to FIG. 3, specifically the operation section 23 has the following elements. They are a power switch K1, an upward cursor key K2, a downward cursor key K3, a leftward cursor key K4, a rightward cursor key K5, a return key K6, an input key K7, a menu key K8, a setup key K9, LEDs (light emitting diodes) L1 to L4, and an enter key K10.

FIG. 4 is a cross section view showing one example of an optical configuration of the projector as an embodiment of the present invention.

As shown in FIG. 4, in an optical configuration of the projector 1, a projection lamp 31 is disposed near an optical unit 41. Illuminating light emitted from optical unit 41 is passed through a multilens system 42 and a convex lens 43 provided adjacent the multilens system 42, passed through or reflected off a transmissive mirror 44, and is then transmitted through each LCD section 36R, 36G, 36B.

Thereby, the illuminating light from the lamp section 31 is projected in an image-carrying state through the projection lens 37 and is then imaged on a screen (not shown) or the like. The projection lens 37 incorporates a built-in focus motor/zoom motor, in which each control signal are supplied from the control section 27 and appropriate focus control and zoom control are responsively performed.

FIG. 5 is a plan section view showing one example of a remote controller used with the projector as an embodiment of the present invention.

As shown in FIG. 5, the remote controller used with the projector 1 according to one embodiment of the present invention includes various keys and buttons. As an illustrative example, these keys and buttons include, but are not limited or restricted to the following: an input switch button 51 for switching of input signals; a selection/OK button 52 including an upward cursor key 52-1, a downward cursor key 52-2, a leftward cursor key 52-3, a rightward cursor key 52-4, and an enter key 52-5 for performing selection or determine in selection or adjustment at menu; a menu button 53 for performing menu display; various setting switches 54; the picture mode buttons 55 for selecting a video image mode; a size button 56 for selecting the screen size; a user button 57 for calling a registered user setup; a freeze button 58 for freezing the motion of images; a surround button 59 for performing mode selection regarding a surround effect; a sleep button 60 for temporarily turning off image and voice presentations; and a zoom button 61 for performing magnified screen display.

In a configuration where the projector 1 as an embodiment is connected to an external device, although not shown, a video deck (external input device) may be connected thereto by using CVBS terminal 16, audio terminal 18, and/or S-video terminal 15. In addition, the projector 1 may be connected with a DVD player (external input device) by using YCbCr terminal 14. Generally, the projector 1 as an embodiment of the present invention may be connected with a personal computer (external input device) by using D-SUB terminal 13.

### B. Basic Operation

Basic operation of the projector 1 described above will now be described in detail herein below with reference to the drawings. To begin with, when a power-on operation of the operation section 23 or an operation of the remote controller has been recognized, when the below-described security function of the lamp power-supply is not as yet set, the projector 1 is activated, and a video signal specified by the input switch button 51 or the like is selected by the input/output selection section 20.

More specifically, in this stage, “YPbPr” button, for example, is selected by the operation of the input switch button 51 of the remote controller or the like, a component video signal from the external DVD player is selected by the input/output selection section 20 through YCbCr terminal 14. Then, the component video signal is determined by the input/output selection section 20 for the signal type, in which an image conversion process is performed corresponding to the signal type, and an RGB signal is then output.

The above is not limited to the case of the component signal received from the YPbPr terminal 14, but is applicable to other cases. For example, suppose that a video signal is received from a network through the wireless LAN 10 or the wired LAN 11, or a video signal is received from tuner section 12, or a video signal is received from S-video terminal 15, or a video signal, which is a composite signal, is received from CVBS terminal 16.

Even in the each case, the same operation as that described above is performed in such a manner that the signal is specified by operation section 23 or 24, the type of the video signal is determined, and the video signal is image-converted to an RGB signal.

The RGB signal supplied from the input/output selection section 20 is supplied to the control section 27. Concurrently, control signals are supplied by the setup-mode set section 33 to the video process section 34 in correspondence to, for example, an image pattern and video image size specified using the size button 56 by the operation section 23 or the remote control section 24. In the video process section 34, the image conversion process is performed on the RGB signal, which has been supplied from the control section 27, in correspondence to the supplied control signals from the setup-mode set section 33. Thereby, the video signal is converted to an RGB signal in conformity to the specified image pattern and video image size.

Now suppose that operation of the picture mode buttons 55 for selecting the video image mode specifies “CINEMA”. In this event, an image process is performed on an RGB signal corresponding to the specified video image mode, and the RGB signal is then converted into a movie-representing video signal, for example.

Video signals thus converted are supplied from the video process section 34 to the expander section 35, is expanded for each of the R, G, and B signals, and are displayed to LC (liquid crystal) screens of each R LCD section 36R, G LCD section 36G, and B LCD section 36B. Concurrently, in a driver section 30 to which the electronics power has been supplied from the power-supply section 29, output is controlled to, for example, 100% output or 50% output, and a driving current is supplied therefrom to the lamp section 31.

Projection light corresponding to the driving current is generated in the lamp section 31. Then, as shown in FIG. 4, the projection light is passed through the multilens system 42 and convex lens 43 provided adjacent the multilens system 42, passed through or reflected off a transmissive mirror 44, and is transmitted through each LCD section 36R, 36G, and 36B. Thereby, the projection light from the lamp section 31 is projected in an image-carrying state through the projection lens 37 and is then imaged on a screen (not shown) or the like. The projection lens 37 incorporates a built-in focus motor/zoom motor, in which each control signal are supplied from the control section 27 and appropriate focus control and zoom control are responsively performed.

Further, in correspondence to the operation section 23 or the remote control section 24, such as operation of the zoom button 61 or the like, the control signals generated in the control section 27 are supplied to, for example, the focus motor and zoom motor, whereby to impart appropriate focus and zoom control, for example, to the projection light.

### C. Authentication Process (Security Function) at Power-On Time

The projector 1 having basic functionality as described above, performs an authentication process (security function) of the lamp power-supply as described below.

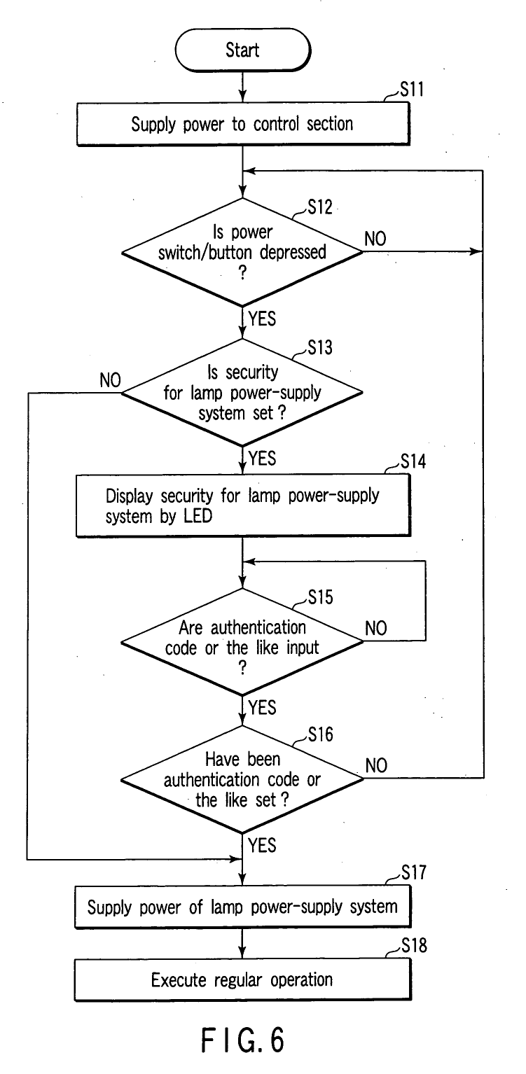

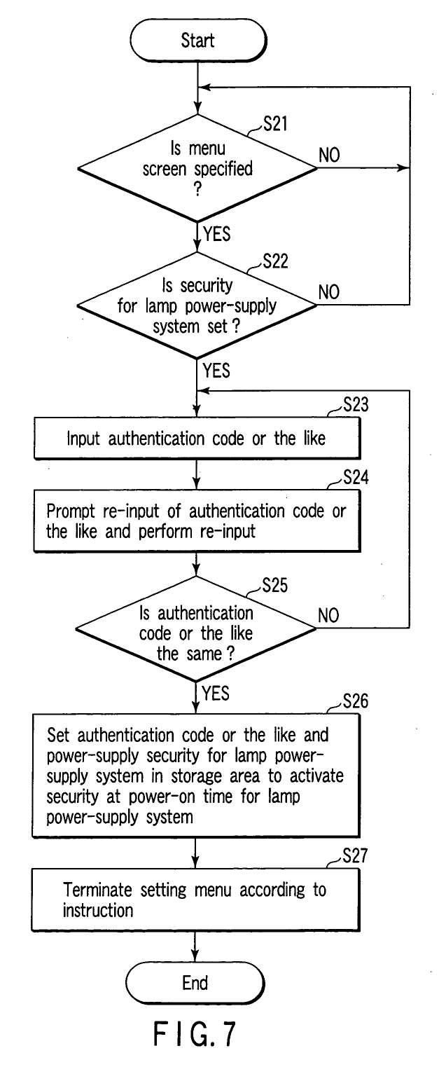

The authentication process at time of power supply will now be described in detail herein below with reference to the drawings. FIG. 6 is a flow chart showing an example of an authentication operation of the projector 1 as an embodiment of the present invention. FIG. 7 is a flow chart showing one example of a setting operation of the security function of the projector 1 as an embodiment of the present invention.

### C-1. Authentication Process

Firstly, the authentication process at time of power supply will be described with reference to the flow chart of FIG. 6. In the projector 1, a power cord from the power-supply section 29 is plugged into, for example, a home-use receptacle, in which when an AC voltage is applied to the power-supply section 29, a predetermined power of, for example, 5 V or 12 V is supplied to the control section 27 (block S11).

In this state, the processing enters a standby mode, specifically, a power-on standby mode awaiting an event where power switch K1 is depressed by a user (alternatively, the power-on operation can be performed using the remote controller). This state is a preparatory stage for power-on with power switch K1 or the like, in which the switch section 32-2 is off; that is, power is unsupplied from the power supply section 29, so that the lamp section 31 is not turned on.

Upon depression of the power switch K1 (block S12), processing of the control section 27 determines whether the authentication process at time of power supply is set for the lamp-power-supply control section 32 of the control section 27 (block S13). If the security function is not operating, the state enters a power-on state (block S17).

According to one embodiment of the invention, the process may be configured as follows. If the security function is operating, the state becomes ready to receive an authentication code, and the lamp-power-supply control section 32 of the control section 27 controls, for example, LEDs L1 to L4 to blink, thereby presenting a display indicating that the security function has been set and that prompts input with the operation switches (block S14). In addition, the operation display section 23-2 of the operation section 23 may present the display to notify that a security function is set and to prompt the input. Further, as an optional feature, a prompting sound is output from a speaker 19 through audio amp 22, or an audio component (not shown) is used to output a prompting “beep” sound.

In response to the above, the user inputs the authentication code by using either main body keys K1 to K10 shown in FIG. 3 or input buttons 51 to 61 shown in FIG. 5 (block S15). Responsively, the lamp-power-supply control section 32 of the control section 27 compares the input operation sequence with the authentication code stored in the operation sequence storage section 32-3 of the control section 27 to determine whether a match is detected (block S16).

If the comparison results in a mismatch, the processing returns to the power-on standby mode of the above-described block S12 to await depression of the power switch K1. In this event, as described above, the processing preferably notifies of the mismatch by means of, for example, blinking LEDs L1 to L4, display on the operation display section 23-2, beep sound from the speaker 19.

If the comparison results in a match between the user-input operation-switch sequence and the authentication code being stored in the operation sequence storage section 32-3 (block S16), a control signal is supplied to the switch section 32-2 from the lamp-power-supply control section 32, and power of the lamp power-supply system is supplied from the power-supply section 29 (block S17). In this stage, if a portion awaiting the power supply is present, power is supplied in a manner similar to the above, whereby the state thereof is shifted to a normal operation mode (block S18).

In this stage, however, an event is contemplated in which while security is not completely cancelled and an additionally predetermined authentication code such as password input or key operation is requested even after the power supply, responsive operations cannot be performed. To deal with this event, the process may be arranged such that even when a video signal is supplied, the video process section 34 and the expander section 35 are controlled by the control section 27 to not allow display on the R LCD section 36R, the G LCD section 36G, and the B LCD section 36B. Thereby, very high security is imparted to the projector 1.

### C-2. Setting Processing

In the above stage, the operation sequence of, for example, the operation section 23 or the remote controller R is arbitrarily settable. The following will describe the settable operation sequence in detail. As shown in a flow chart of FIG. 7, in addition to a regular adjustment setting menu, a dedicated security-function setting menu is preferably provided to enhance the level of protection regarding operation and termination of the security function the authentication-code registration.

A menu screen is invoked (block S21), and further, a dedicated security-function setting menu is invoked, whereby operation is performed to switch the mode of the security function of the lamp power-supply system from a termination mode to an operation mode (block S22). Then, an authentication code for permitting the power-on operation is input (block S23).

In this stage, various settings can be performed for operation of the operation switches to input a pre-stored authentication code. That is, various keys can be used including, for example, the individual upward, downward, leftward, and rightward cursor keys K2 to K5, the input key K7, the return key K6, the menu key K8, the setup key K9, and the enter key K10. These keys may be depressed in combination in such a manner as “upward K2, upward K2, leftward K4, rightward K5, then rightward K5” keys. As an illustrative example, one type of operation-switch operation procedure for inputting a pre-stored authentication code may include a depression procedure as “input key K7, menu key K8, return key K6, then return key K6”, which is not popularly contemplated in regular operations.

It is also noted that predetermined operation switches of the remote controller be depressed in a predetermined procedure. Further, the procedure may be set such that the power switch K1 (or an other key) is kept depressed for a predetermined time frame, e.g. 10 seconds, to thereby performing the setting. Moreover, the procedure may be set such that power switch K1 (or an other key) is depressed predetermined number of times, e.g. five times. Thus, the operation switches for inputting the authentication code can be set independently of regular operations, with all combinations for the overall operation section.

Re-input of the input, pre-stored authentication code is prompted (block S24). If the two inputs are identical to each other, power-supply security is in the operation mode, and concurrently, the operation-switch sequence representing the pre-stored authentication code is stored into the operation sequence storage section 32-3 under control of the lamp-power-supply control section 32 (blocks S25 and S26). Finally, the setting menu is terminated responsively to an instruction (block S27).

According to the operations described above, the security function of the lamp power-supply system is set. This prevents a situation, for example, where a power-on operation is performed by an undue outsider, thereby shortening the service life of the expensive lamp section. In addition, according to the projector, such events can be prevented in which unnecessary power-on/off operations causes the lamp section to fade out, and the power of the projector is inadvertently turned on due to an erroneous operation.

As described above in detail, the projector is characterized as follows. An authentication process for power supply to the lamp section is performed at power-on time. An operation sequence of operation switches is pre-stored in a user setup operation. Then, when a user depresses the power switch to perform a power-on operation, light emitting diodes or the like blink to prompt execution of the authentication process with the operation switches or the like. In this stage, while power is supplied to a control section and others, the power is not supplied to the lamp section, whereby security is imparted to the projector.

Specifically, with a projector, a fault event is predicted in which since the projector is powered on by an undue outsider whereby turning on the lamp and is left as is for as long as one month, a service life of the expensive lamp section is used up thereby. Such the fault event can be prevented according to the authentication process with the operation switches or the like. Further, according to the projector, such events can be prevented in which unnecessary power-on/off operations causes the lamp section to fade out, and the power of the projector is inadvertently powered on due to an erroneous operation.

Selection of a pre-stored authentication code, which may be selected through an input sequence of predetermined operation switches for example, can be arbitrarily set by a user from a menu screen. For example, the procedure is used for depression of at least one of the individual upward, downward, leftward, and rightward cursor keys, the input key, the return key, the menu key, the setup key, and the enter key. That is, the cursor keys may be depressed in such a manner as “upward, upward, leftward, rightward, then rightward” keys. Further, according to another example, the operation-switch operation procedure may be such a key depression procedure as “input key, menu key, return key, then return key”, which is not popularly contemplated in regular operations. It is also contemplated that the power switch is kept depressed for, for example, eight seconds for specification.

According to the various embodiments described above, those skilled in the art will be able to implement the invention, and various other modified examples would easily occur to those skilled in the art. For instance, in lieu of selecting a sequence of operation switches as an authentication code, an electronic image may be stored such as a fingerprint, retina scan, face geometry and the like. The projector may be implemented with a reader to compare the pre-stored electronic image and allow power to be supplied to the lamp section. Accordingly, the invention is not limited to the above-described embodiments, but the invention covers a broad range of applications as long as the applications do not contradict the principles and novel features disclosed herein.

For example, whereas the above-described embodiments have each been described with reference to the example projector, the invention is enforceable with a wide variety of electronic devices. Particularly, the invention is of course adaptable with to electronic devices in a similar manner to those described above with similar operation and effects to those described above as long as the devices contain components such as a projector lamp section specifically desired to be protected.

1. A projection device comprising:
a power-supply;
a power-supply control section to receive power from the power-supply and to selectively supply the power;
a lamp section supplied with the power from the power-supply control section, the lamp section to radiate a projection light; and
a control section to perform an authentication process by comparing input data with a pre-stored authentication code in order to control the power-supply control section in supplying the power to the lamp section.

2. The projection device according to claim 1, wherein the control section to control the power-supply control section by permitting the power to be supplied to the lamp section when the input data matches the pre-stored authentication code.

3. The projection device according to claim 2, further comprising an operation section that comprises a plurality of operation switches including a power switch that, when depressed, supplies power to the control section and is used during the authentication process.

4. The projection device according to claim 3, further comprising an operation display section to present a display prompting a user to perform input using said operation section when said control section detects depression of said power switch when the authentication process for determining presence or absence of a predetermined operation of said operation section is set.

5. The projection device according to claim 3, wherein the control section stores said pre-stored authentication code being a stored sequence of operation switches of the operation section depressed by a user.

6. The projection device according to claim 3, wherein the pre-stored authentication code is a sequence of depression of at least one of upward, downward, leftward, and rightward cursor keys, an input key, a return key, a menu key, a setup key, and an enter key of the operation section.

7. The projection device according to claim 3, wherein the pre-stored authentication code includes a sequence of one or more predetermined operation switches of a remote controller depressed by a user.

8. The projection device according to claim 7, wherein the sequence of one or more predetermined operation switches are depressed within a predetermined period of time.

9. The projection device according to claim 1, wherein the pre-stored authentication code is a pre-stored electronic image.

10. The projection device according to claim 1, wherein, when the authentication process is cancelled, the control section is adapted to control the power-supply control section to supply the power to the lamp portion without comparison of the pre-stored authentication code.

11. A projection device comprising:
a power-supply control section to selectively supply power to components including a light source which produces a projection light within the projection device; and
a control section to compare between input data supplied by a user and a pre-stored authentication code to control whether power provided by the power-supply control section is supplied to the components.

12. A method of controlling a projection device including a power supply, a light source and an operation section including a plurality of operation switches including a power switch, comprising:
comparing data input by a user with a pre-stored authentication code upon detecting depression of the power switch and determining that an authentication process has been set;
controlling a supply of power from the power supply to the light source, if the input data matches the pre-stored authentication code; and
starting said light source to radiate a projection light when the data input by the user matches the pre-stored authentication code.

13. The method of controlling the projection device according to claim 12, wherein prior to comparing the input data with the pre-stored authentication code, the method further comprising:
presenting a display prompting the user to depress a plurality of operation switches to produce the input data in response to detecting depression of the power switch.

14. The method of controlling the projection device according to claim 12 further comprising:
controlling preventing the supply of power to the light source if the input data fails to match the pre-stored authentication code.

15. The method of controlling the projection device according to claim 13, wherein prior to comparing the input data with the pre-stored authentication code, the method further comprising:
storing said pre-stored authentication code, being a stored sequence of operation switches depressed by a user, into a memory within the projection device.

16. The method of controlling the projection device according to claim 12, wherein the pre-stored authentication code is a sequence of depressed, operation switches including at least one of an upward, downward, leftward, and rightward cursor keys, an input key, a return key, a menu key, a setup key, and an enter key.

17. The method of controlling the projection device according to claim 12, wherein the pre-stored authentication code is a sequence of one or more predetermined operation switches of a remote controller depressed by a user.

18. The method of controlling the projection device according to claim 17, wherein the sequence of operation switches is depressed within a predetermined period of time.

19. The method of controlling the projection device according to claim 12, wherein the pre-stored authentication code is a pre-stored electronic image.

20. The method of controlling the projection device according to claim 12, wherein prior to comparing the input data with the pre-stored authentication code, the method further comprising:
determining is an authentication process is set, and if not, supplying power to the light source without comparison of the pre-stored authentication code.
